(19) United States
(12) Patent Application Publication
(10) Pub. No.: US 2013/0277305 A1
(43) Pub. Date: Oct. 24, 2013

(54) SELECTIVELY PERFORATED GRAPHENE MEMBRANES FOR COMPOUND HARVEST, CAPTURE AND RETENTION

(71) Applicant: LOCKHEED MARTIN CORPORATION, Bethesda, MD (US)

(72) Inventors: John B. STETSON, JR., New Hope, PA (US); Stanley J. Viss, Philadelphia, PA (US)

(73) Assignee: LOCKHEED MARTIN CORPORATION, Bethesda, MD (US)

(21) Appl. No.: 13/779,963

(22) Filed: Feb. 28, 2013

Related U.S. Application Data
(60) Provisional application No. 61/635,378, filed on Apr. 19, 2012.

(51) Int. Cl. B01D 65/02

(52) U.S. Cl. CPC B01D 65/02
USPC 210/636; 210/653; 210/321.69

(57) ABSTRACT

Devices and related methods for arresting and retaining molecules from solution upon the surface of a perforated graphene membrane with plural apertures selected to allow passage of the solutions' solvent while simultaneously arresting desired molecules upon the surface of the membrane. The method continues with arranging the perforated graphene membranes in a sequence of successively smaller plural aperture diameters to arrest and retain successively smaller molecules in series. The dislodging devices include electromagnetic, electromechanical and electrostatic configurations.

### CROSS-REFERENCE TO RELATED APPLICATIONS

This application claims priority of U.S. provisional application Ser. No. 61/635,378 filed Apr. 19, 2012 and entitled Selectively Perforated Graphene membranes For Compound Harvest, Capture And Retention, and is incorporated herein by reference.

### TECHNICAL FIELD

This application relates to the use of selectively perforated carbon single and several layer graphene membranes for the purposes of intentional harvest, capture and retention of desired compounds from solution passing through the membrane, or a suitable arrangement of the membranes.

### BACKGROUND ART

As fresh water resources are becoming increasingly scarce, many nations are seeking solutions that can convert water that is contaminated with salt, most notably seawater, into clean drinking water.

Existing techniques for water desalination fall into four broad categories, namely distillation, ionic processes, membrane processes, and crystallization. The most efficient and most utilized of these techniques are multistage flash distillation (MSF), multiple effect evaporation (MEE) and reverse osmosis (RO). Cost is a driving factor for all of these processes, v/here energy and capital costs are both significant. Both RO and MSF/MEE technologies are thoroughly developed. Currently, the best desalination solutions require between two and four times the theoretical minimum energy limit established by simple evaporation of water, which is in the range of 3 to 7 kjoules/kg. Distillation desalination methods include multistage flash evaporation, multiple effect distillation, vapor compression, solar humidification, and geothermal desalination. These methods share a common approach, which is the changing of the state of water to perform desalination. These approaches use heat-transfer and/or vacuum pressure to vaporize saline water solutions. The water vapor is then condensed and collected as fresh water. Ionic process desalination methods focus on chemical and electrical interactions with the ions within the solution. Examples of ionic process desalination methods include ion exchange, electro-dialysis, and capacitive deionization. Ion exchange introduces solid polymeric or mineral ion exchangers into the saline solution. The ion exchangers bind to the desired ions in solution so that they can be easily filtered out. Electro-dialysis is the process of using cation and anion selective membranes and voltage potential to create alternating channels of fresh water and brine solution. Capacitive deionization is the use of voltage potential to pull charged ions from solution, trapping the ions while allowing water molecules to pass. Membrane desalination processes remove ions from solution using filtration and pressure. Reverse osmosis (RO) is a widely used desalination technology that applies pressure to a saline solution to overcome the osmotic pressure of the ion solution. The pressure pushes water molecules through a porous membrane into a fresh water compartment while ions are trapped, creating high concentration brine solution. Pressure is the driving cost factor for these approaches, as it is needed to overcome osmotic pressure to capture the fresh water. Crystallization desalination is based on the phenomenon that crystals form preferentially without included ions. By creating crystallized water, either as ice or as a methyl hydrate, pure water can be isolated from dissolved ions. In the case of simple freezing, water is cooled below its freezing point, thereby creating ice. The ice is then melted to form pure water. The methyl hydrate crystallization processed uses methane gas percolated though a saltwater solution to form methane hydrate, which occurs at a lower temperature than at which water freezes. The methyl hydrate rises, facilitating separation, and is then warmed for decomposition into methane and desalinated water. The desalinated water is collected, and the methane is recycled.

Evaporation and condensation for desalination is generally considered to be energy efficient, but requires a source of concentrated heat. When performed in large scale, evaporation and condensation for desalination are generally co-located with power plants, and tend to be restricted in geographic distribution and size.

Capacitive deionization is not widely used, possibly because the capacitive electrodes tend to foul with removed salts and to require frequent service. The requisite voltage tends to depend upon the spacing of the plates and the rate of flow, and the voltage can be a hazard.

Reverse osmosis (RO) filters are widely used for water purification. The RO filter uses a porous or semipermeable membrane typically made from cellulose acetate or polyimide thin-film composite, typically with an overall thickness of 1 mm. These materials are hydrophilic. The membrane is often spiral-wound into a tube-like form for convenient handling and membrane support. The membrane exhibits a random-size aperture distribution, in which the maximum-size aperture is small enough to allow passage of water molecules and to disallow or block the passage of ions such as salts dissolved in the water. Notwithstanding the one-millimeter thickness of a typical RO membrane, the inherent random structure of the RO membrane defines long and circuitous or tortuous paths for the water that flows through the membrane, and these paths may be much more than one millimeter in length. The length and random configuration of the paths require substantial pressure to strip the water molecules at the surface from the ions and then to move the water molecules through the membrane against the osmotic pressure. Thus, the RO filter tends to be energy inefficient.

FIG. 1 is a notional illustration of a cross-section of an RO membrane 10. In FIG. 1, membrane 10 defines an upstream surface 12 facing an upstream ionic aqueous solution 16 and a downstream surface 14. The ions that are illustrated on the upstream side are selected as being sodium (Na) with a + charge and chlorine (CI) with a − charge. The sodium is illustrated as being associated with four solvating water molecules (H₂0). Each water molecule includes an oxygen atom and two hydrogen (H) atoms. One of the pathways 20 for the flow of water in RO membrane 10 of FIG. 1 is illustrated as extending from an aperture 20u on the upstream surface 12 to an aperture 20d on the downstream surface 14. Path 20 is illustrated as being convoluted, but it is not possible to show the actual tortuous nature of the typical path. Also, the path illustrated as 20 can be expected to be interconnected with multiple upstream apertures and multiple downstream apertures. The path(s) 20 through the RO membrane 10 are not only convoluted, but they may change with time as some of the apertures are blocked by unavoidable debris.

Alternative water desalination or deionization is desired.

In relation to desalination and deionization there is also a need in industrial, commercial and pharmaceutical technologies for capturing and retaining compounds of high value from dissolved solutions containing them. The cost of producing, extracting and refining these compounds from an original source increases through a combination of scarcity, energy and transportation cost. Therefore high performance, selective, durable harvest membranes that accommodate a variety of compound dislodging and capture means are sought.

Existing harvest and capture devices consist of variants of thick, porous membranes, columns packed with absorbant (or adsorbant) spheres, and chormotographic or electrophoretic devices. The devices associated with these approaches suffer from restricted performance—measured as captured volume of the desired compound per unit time, per unit area. This is primarily because the input multi-component mixture flow is greatly impeded as it flows through the aforementioned arrangements. The primary reason for this poor performance is expressed in the flow equation of D'Arcy, that describes the flow of a fluid at low velocity through a porous media:

J=βΔp/d 1)

Where J is the flux through the membrane (m³/sec/m²), Δp is the pressure difference across the membrane (N/m²), β is a membrane friction parameter, and d is the membrane thickness (m). Existing membrane and sphere arrangements have thicknesses ranging from 50-100 microns (10⁻⁶ m) and tortuous paths associated with the parameter β in the range of 0.5 to as small as 0.05.

Based on the foregoing, there is a clear need in the art for improved membranes. Accordingly, the present disclosure provides for graphene membranes where the nominal thickness of single to few layer graphene is 0.3×10⁻⁹ m with β=1; which results in an overall theoretical advantage in efficiency of permeation of 330,000:1.

In addition to its dimensional advantage, graphene is also extremely strong with a Young's Modulus 1000 times larger than steel. It is also conductive so that it may possess a charge relative to the surrounding solution, and is magnetically neutral. These facts allow a range of unique methods to be applied to dislodging desired compounds from the graphene surface for subsequent capture and retention.

### SUMMARY OF THE INVENTION

In light of the foregoing, it is a first aspect of the present invention to provide selectively perforated graphene membranes for compound harvest, capture and retention.

It is another aspect of the present invention to provide a method for collecting molecules from solution comprising providing at least one graphene membrane perforated with a plurality of apertures selected to allow passage of the solutions' solvent while simultaneously arresting desired molecules upon a surface of the at least one graphene membrane, and dislodging the accumulated desired molecules from the surface for capture and retention.

It is another aspect of the present invention set out above to include halting flow of the solution when accumulation of the desired molecules reaches a predetermined amount.

It is still another aspect of the method set out above to provide dislodging by locating two electromagnet coils spaced above and below the at least one graphene membrane, and applying controlled current to the electromagnetic coils to generate an electromagnetic attraction force on any one of the molecule constituents responsive to Ferromagnetic attraction so as to dislodge the molecules from the surface. After dislodging, the method may continue by flowing a free solution across the surface to harvest the desired dislodged molecules.

It is yet another aspect of the method set out above to provide dislodging by associating the at least one graphene membrane with at least one porous piezo-electric substrate, and applying a voltage to the at least one porous piezo-electric substrate to produce mechanical deflection causing vertical dislodging of one of the molecule constituents so as to dislodge the molecules from the surface. After dislodging, the method may continue by flowing a free solution across the surface to harvest the desired dislodged molecules.

It is a further aspect of the method set out above to provide connecting an electromagnetic wave generating circuit between an outer diameter and a proximal center reference of the at least one graphene membrane, and applying an electromagnetic wave to at least one graphene membrane to produce a combined lateral charge and vertical mechanical deflection causing vertical dislodging of one of the desired molecule constituents so as to dislodge the molecules from the surface. The method may continue by flowing a free solution across the surface to harvest the desired dislodged molecules.

It is another aspect of the invention to provide an apparatus for selectively harvesting molecules, comprising a vessel having an inlet and an outlet, the inlet receiving a solution and the outlet collecting the solution's solvent, at least one graphene membrane perforated with a plurality of apertures selected to allow passage of the solution's solvent while simultaneously arresting desired molecules upon a surface of the at least one graphene membrane, and a dislodging device associated with the at least one graphene membrane to dislodge the desired molecules from the surface.

It is another aspect of the invention to provide a detection device associated with the at least one graphene membrane to monitor accumulation of the desired molecules upon the surface.

It is yet another aspect of the invention to provide a cross-flow inlet and a cross-flow outlet associated with the vessel, the cross-flow inlet positioned to distribute a free solution over the at least one graphene membrane to harvest the desired dislodged molecules and wherein the cross-flow outlet accumulates the free solution and desired dislodged molecules.

In one embodiment of the invention, the dislodging device comprises a pair of electromagnetic coils having a gap therebetween, wherein the at least one graphene membrane is received in the gap, and a current source applying current to at least one of the electromagnetic coils to generate an electromagnetic attraction force to dislodge the desired molecules from the surface.

In another embodiment, the dislodging device comprises at least one porous piezo-electric substrate associated with the at least one graphene membrane, and a voltage source connected to the at least one porous piezo-electric substrate to generate a mechanical deflection and dislodge the desired molecules from the surface.

In still another embodiment, the dislodging device comprises an electromagnetic wave generating circuit connected between an outer edge of the at least one graphene membrane and a proximal center reference of the at least one graphene membrane, wherein generation of the electromagnetic wave generates a combined lateral charge and vertical mechanical deflection causing dislodging of the desired molecules from the surface.

### BRIEF DESCRIPTION OF THE DRAWINGS

This and other features and advantages of the present invention will become better understood with regard to the following description, appended claims, and accompanying drawings wherein:

FIG. 1 is a notional cross-sectional representation of a prior-art reverse osmosis (RO) filter membrane;

FIG. 2 is a notional representation of a water filter according to an aspect of the disclosure, using a perforated graphene sheet;

FIG. 3 is a plan representation of a perforated graphene sheet which may be used in the arrangement of FIG. 2, showing the shape of one of the plural apertures;

FIG. 4 is a plan view of a perforated graphene sheet, showing six tenths (0.6) nanometer diameter perforations or apertures and interperforation dimensions;

FIG. 5 is a plan representation of a backing sheet that may be used in conjunction with the perforated graphene sheet of FIG. 2;

FIG. 6 is a notional representation of a water deionization filter according to aspects of the disclosure, using multiple perforated graphene sheets for separation of the concentrated ions; and

FIG. 7 is a simplified diagram illustrating a plumbing arrangement corresponding generally to the arrangement of FIG. 6, in which the perforated graphene sheets are spirally wound and enclosed in cylinders;

FIG. 8 is a schematic diagram (not to scale) of a graphene harvesting manifold according to the concepts of the present invention;

FIG. 9 is a schematic diagram of an electromagnetic dislodging means according to the concepts of the present invention when used in conjunction with the manifold shown in FIG. 8;

FIG. 10 is a schematic diagram of an electromechanical dislodging means according to the concepts of the present invention when used in conjunction with the manifold shown in FIG. 8; and

FIG. 11 is a schematic diagram of an electrostatic dislodging means according to the concepts of the present invention when used in conjunction with the manifold shown in FIG. 8.

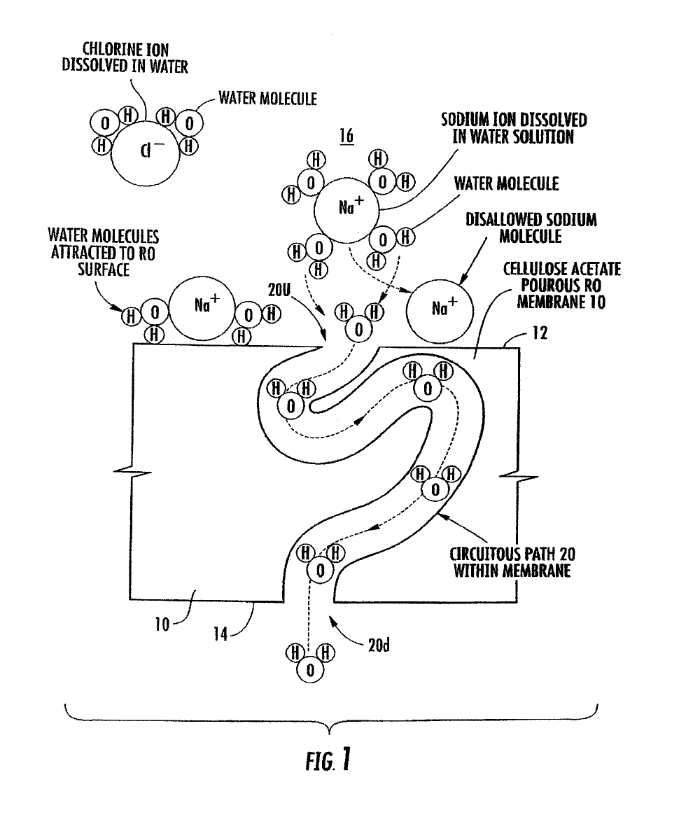

### BEST MODE FOR CARRYING OUT THE INVENTION

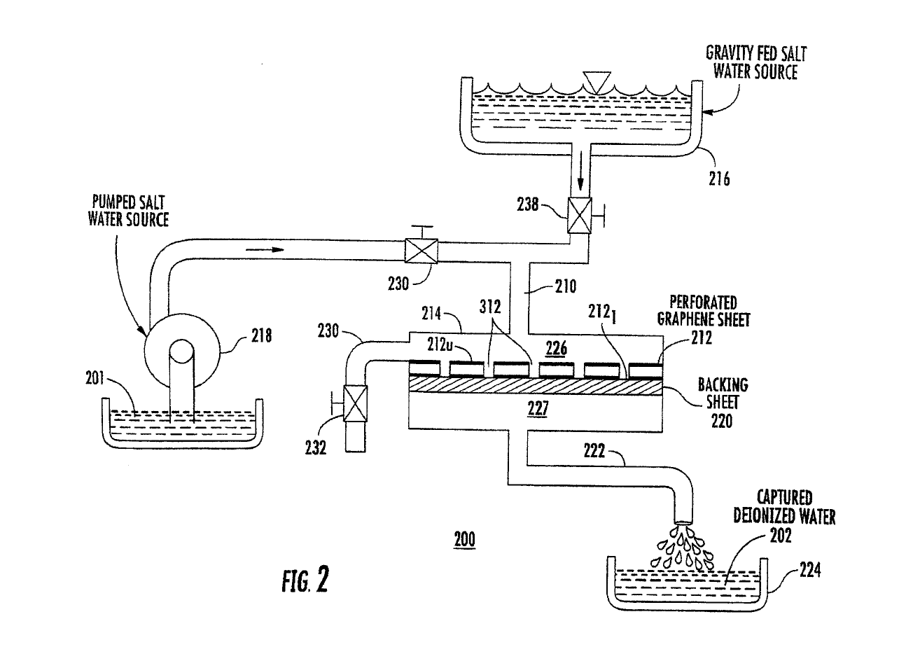

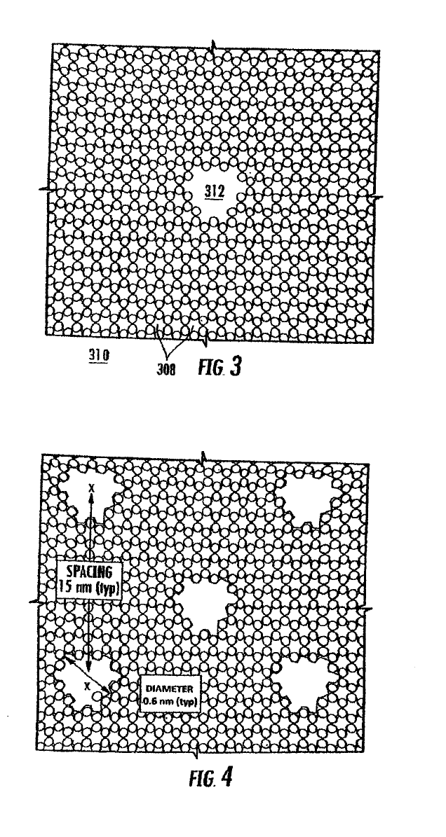

FIG. 2 is a notional representation of a basic desalination, desalinization or deionization apparatus 200 according to an exemplary embodiment or aspect of the disclosure. In FIG. 2, a channel 210 conveys ion-laden water to a filter membrane 212 mounted in a supporting chamber 214. The ion-laden water may be, for example, seawater or brackish water. In one exemplary embodiment, the filter membrane 212 can be wound into a spiral in known manner. Flow impetus or pressure of the ion-laden water flowing through channel 210 of FIG. 2 can be provided either by gravity from a tank 216 or from a pump 218. Valves 236 and 238 allow selection of the source of ion-laden water. In apparatus or arrangement 200, filter membrane 212 is a perforated graphene sheet. Graphene is a single-atomic-layer-thick layer of carbon atoms, bound together to define a graphene sheet 310, as illustrated in FIG. 3. The thickness of a single graphene sheet is approximately 0.2 to 0.3 nanometers (nm). Multiple graphene sheets can be formed, having greater thickness and correspondingly greater strength. Multiple graphene sheets can be provided in multiple layers as the sheet is grown or formed. Or multiple graphene sheets can be achieved by layering or positioning one sheet on top of another. For all the embodiments disclosed herein, a single sheet of graphene or multiple graphene sheets may be used. Testing reveals that multiple layers of graphene maintain their integrity and function as a result of self-adhesion. This improves the strength of the sheet and in some cases flow performance. The carbon atoms of the graphene sheet 310 of FIG. 3 define a repeating pattern of hexagonal ring structures (benzene rings) constructed of six carbon atoms, which form a honeycomb lattice of carbon atoms. An interstitial aperture 308 is formed by each six carbon atom ring structure in the sheet and this interstitial aperture is less than one nanometer across. Indeed, skilled artisans will appreciate that the interstitial aperture 308 is believed to be about 0.23 nanometers across at its longest dimension. Accordingly, the dimension and configuration of the aperture 308 and the election nature of the graphene precludes transport of any molecule across the graphene's thickness unless there are perforations. This dimension is much too small to allow the passage of either water or ions. In order to form the perforated graphene sheet 212 of FIG. 2, one or more perforations are made, as illustrated in FIG. 3. A representative generally or nominally round aperture 312 is defined through the graphene sheet 310. Aperture 312 has a nominal diameter of about six-tenths (0.6) nanometers. The six-tenth nanometer dimension is selected to block the smallest of the ions which would ordinarily be expected in salt or brackish water, which is the sodium ion. The generally round shape of the aperture 312 is affected by the fact that the edges of the aperture are defined, in part, by the hexagonal carbon ring structure of the graphene sheet 310.

Aperture 312 may be made by selective oxidation, by which is meant exposure to an oxidizing agent for a selected period of time. It is believed that the aperture 312 can also be formed by charged particle bombardment thereafter followed by the aforementioned selective oxidation. As described in the publication Nano Lett. 2008, Vol. 8, no. 7, pg 1965-1970, the most straightforward perforation strategy is to treat the graphene film with dilute oxygen in argon at elevated temperature. As described therein, through apertures or holes in the 20 to 180 nm range were etched in graphene using 350 mTorr of oxygen in 1 atmosphere (atm) argon at 500° C. for 2 hours. The paper reasonably suggests that the number of holes is related to defects in the graphene sheet and the size of the holes is related to the residence time. This is believed to be the preferred method for making the desired perforations in graphene structures. The structures may be graphene nanoplatelets and graphene nanoribbons. Thus, apertures in the desired range can be formed by shorter oxidation times. Another more involved method as described in Kim et al. “Fabrication and Characterization of Large Area, Semiconducting Nanoperforated Graphene Materials,” Nano Letters 2010 Vol. 10, No. 4, Mar. 1, 2010 pp 1125-1131, utilizes a self assembling polymer that creates a mask suitable for patterning using reactive ion etching. A P(S-blockMMA) block copolymer forms an array of PMMA columns that form vias for the RIE upon redeveloping. The pattern of holes is very dense. The number and size of holes is controlled by the molecular weight of the PMMA block and the weight fraction of the PMMA in the P(S-MMA). Either method has the potential to produce perforated graphene sheets.

As mentioned, the graphene sheet 310 of FIG. 3 has a thickness of but a single atom. Thus, the sheet tends to be flexible. The flex of the graphene sheet can be ameliorated by applying a backing structure to the sheet 212. In FIG. 2, the backing structure of perforated graphene sheet 212 is illustrated as 220. Backing structure 220 in this embodiment is a sheet of perforated polytetrafluoroethylene, sometimes known as polytetrafluoroethane. An alternate effective backing material is a selectively perforated polycarbonate plastic membrane. A thickness of the backing sheet may be, for example, one millimeter (mm).

It should be noted that, in the apparatus or arrangement of FIG. 2, the pressure of ion-laden water applied through path 210 to the perforated membrane 212 can be provided by gravity from tank 216, thereby emphasizing one of the aspects of the apparatus 200. That is, unlike the RO membrane, the perforated graphene sheet 312 forming the perforated membrane 212 is hydrophobic, and the water passing through the pierced apertures (312 of FIG. 3A) is not impeded by the attractive forces attributable to wetting. Also, as mentioned, the length of the flow path through the apertures 312 in graphene sheet 310 is equal to the thickness of the sheet, which is about 0.2 to 0.3 nm. This length is much less than the lengths of the random paths extending through a RO membrane. Consequently, very little pressure is required to provide fluid flow, or conversely, the flow at a given pressure is much greater in the perforated graphene sheet 310. This, in turn, translates to a low energy requirement for ion separation. It is believed that the pressure required in a RO membrane to force water through the membrane against osmotic pressure includes a frictional component which results in heating of the membrane. Consequently, some of the pressure which must be applied to the RO membrane does not go toward overcoming osmotic pressure, but instead goes into heat. Simulated results show that the perforated graphene sheet reduces the required pressure by at least a factor of five. Thus, where an RO membrane might require forty pounds per square inch (PSI) of pressure on the upstream side to effect a particular flow of deionized water at a particular ion concentration, a perforated graphene sheet for the same flow rate may require eight PSI or less.

As mentioned, the perforations 312 in graphene sheet 212 of FIG. 2 (or equivalently graphene sheet 310 of FIG. 3) are dimensioned to disallow the passage of the smallest ions to be expected in the source water. Consequently, any ions equal to or larger in size than the smallest will not pass through the perforated graphene sheet 212, and such ions can be expected to accumulate in an upstream side 226 of the graphene-sheet-supporting chamber 214. This accumulation of ions in upstream “chamber” 226 is referred to herein as “sludge,” and will eventually reduce the flow of water through the perforated graphene sheet 212, thereby tending to render it ineffective for deionization. As illustrated in FIG. 2, a further path 230 is provided, together with a discharge valve 232, to allow purging or discharge of the sludge. Thus, operation of the apparatus or arrangement 200 of FIG. 2 may be in a “batch” mode. The first mode of the batch operation occurs with flow of ion-laden water through path 210, with discharge valve 232 closed to prevent flow. The ion-laden water fills the upstream side 226 of the support chamber 214. The water molecules are allowed to flow through perforated graphene sheet 212 of FIG. 2 and through the backing sheet 220 to the downstream side 227 of the support chamber 214. Thus, deionized water accumulates in downstream portion 227 for a period of time, and is available to be drawn off through a path 222 to a capture vessel illustrated as a tank 224. Eventually, the accumulation or concentration of ions in upstream portion 226 of the support chamber will tend to reduce the flow of water through the perforated graphene sheet 212. In order to purge the concentrated ion/water mix accumulated on or in the upstream chamber or side 226, valve 232 is opened, which allows the concentrated ion/water mix to be purged while the upstream portion 226 refills with ion-laden water from tank 216 or pump 218. Valve 232 is then closed and another filtration cycle begins. This results in the production of deionized water and accumulation of the deionized water in container 224.

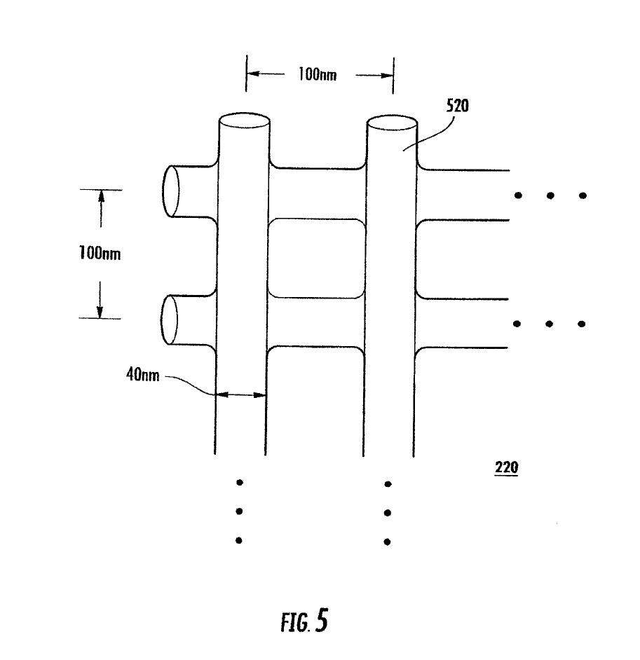

FIG. 4 is a representation of a graphene sheet with a plurality of perforations such as that of FIG. 3. The sheet of FIG. 4 defines [three, four, or five] apertures. In principle, the flow rate will be proportional to the aperture density. As the aperture density increases, the flow through the apertures may become “turbulent,” which may adversely affect the flow at a given pressure. Also, as the aperture density increases, the strength of the underlying graphene sheet may be locally reduced. Such a reduction in strength may, under some circumstances, result in rupture of the membrane. The center-to-center spacing between apertures is believed to be near optimum for the six-tenth (0.6) nanometer apertures at a value of fifteen nanometers.

FIG. 5 is a simplified illustration of the structure of a backing sheet which may be used with the graphene sheet of FIG. 2. In FIG. 5, backing sheet 220 is made from filaments 520 of polytetrafluoroethylene, also known as polytetrafluoroethane, arranged in a rectangular grid and bonded or fused at their intersections. An alternate effective backing material is a selectively perforated polycarbonate plastic membrane. As with the perforated graphene sheet, the dimensions in the backing sheet should be as large as possible for maximum flow, commensurate with sufficient strength. The spacing between mutually adjacent filaments 520 oriented in the same direction can be nominally 100 nm, and the filaments may have a nominal diameter of 40 nm. The tensile strength of the graphene sheet is great, and so the relatively large unsupported areas in the backing sheet should not present problems.

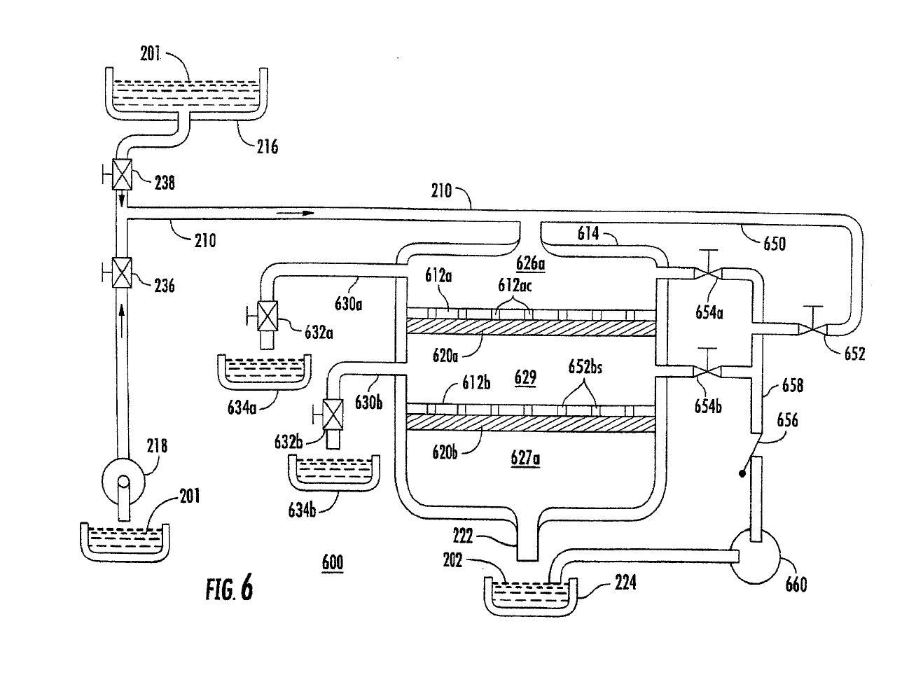

FIG. 6 is a notional illustration of a deionization or desalination apparatus 600 according to another embodiment or aspect of the disclosure, in which multiple layers of differently-perforated graphene sheets are used. In FIG. 6, elements corresponding to those of FIG. 2 are designated by like reference alphanumerics. Within support chamber 614 of FIG. 6, upstream and downstream perforated graphene sheets 612a and 612b, respectively, divide the chamber into three volumes or portions, namely an upstream portion or chamber 626a, a downstream portion or chamber 626b, and an intermediate portion or chamber 629. Each perforated graphene sheet 612a and 612b is associated with a backing sheet. More particularly, perforated graphene sheet 612a is backed by a sheet 620a, and perforated graphene sheet 612b is backed by a sheet 620b. The perforations of the perforated graphene sheets 612a and 612b differ from one another. More particularly, upstream graphene sheet 612a is perforated by apertures 612ac selected to disallow or disable the flow of chlorine ions and to enable the flow of water laden with sodium ions; these apertures are nine-tenth (0.9) nanometers in nominal diameter. Thus, chlorine ions, having a greater effective diameter than nine-tenth (0.9) nanometers, cannot pass through perforated graphene sheet 612a, but remain in the upstream portion or chamber 626a. In some embodiments, it is believed that the apertures 612ac can range from 0.8 to 1.2 nm in nominal diameter and be effective in disallowing or disabling the flow of chlorine ions. Water laden with sodium ions can flow through perforated graphene sheet 612a into intermediate chamber 629. Downstream perforated graphene sheet 612b is perforated with apertures 612bs selected to disallow or disable the flow of sodium ions and to enable the flow of water molecules; these apertures are six-tenth (0.6) nanometers in nominal diameter. Thus, chlorine ions, having a greater effective diameter than nine-tenth (0.9) nanometers or 0.8 to 1.2 nanometers, cannot pass through apertures 612ac of perforated graphene sheet 612a, but water laden with sodium ions can flow through the apertures 612ac of perforated graphene sheet 612a into intermediate chamber 629. Sodium ions cannot pass through downstream perforated graphene sheet 612b, and so remain or accumulate in intermediate portion or chamber 629. The water molecules (H2O), free of at least chlorine and sodium ions, can flow from intermediate portion or chamber 629 through apertures 612bs of perforated graphene sheet 612b and into downstream portion or chamber 627a, from whence the deionized water can be collected through path 222 and collection vessel 224.

As with the case of the deionization arrangement 200 of FIG. 2, the apparatus or arrangement 600 of FIG. 6 accumulates or concentrates ions during deionization operation. Unlike the apparatus or arrangement of FIG. 2, however, deionizer 600 produces at least partially separated concentrations of ions. More particularly, with a flow of water laden with chlorine and sodium ions, upstream portion or chamber 626a of apparatus 600 accumulates a sludge concentration consisting principally of chlorine ions, and intermediate portion or chamber 629 accumulates a concentration principally of sodium ions. These concentrated ions can be separately extracted by selective control of purging connections 630a and 630b and their purge valves 632a and 632b, respectively. More particularly, valve 632a can be opened to allow the concentrated chlorine ions to flow from upstream portion or chamber 626a to a collecting vessel illustrated as a tank 634a, and valve 632b can be opened to allow the concentrated sodium ions to flow from intermediate portion or chamber 629 to a collecting vessel illustrated as a tank 634b. Ideally, purge valve 632a is closed before purging of intermediate portion or tank 629 is begun, so that some pressure is maintained across perforated graphene sheet 612a to provide a flow of water through perforated graphene sheet 612a to aid in flushing the sodium-ion-rich sludge from the intermediate chamber 629. Purge valves 632a and 632b are closed prior to proceeding with the deionization. The purged and collected concentrated ions have economic value, as for conversion into solid form in the case of sodium or gaseous form in the case of chlorine. It should be noted that sea water contains significant amounts of beryllium salts, and these salts, if preferentially concentrated, have value to the pharmaceutical industry as a catalyst.

Also illustrated in FIG. 6 are cross-flow valves 654a and 654b, communicating between a flow path 658 and upstream portion or chamber 626a and intermediate portion or chamber 626b, respectively. Unfiltered water 201 loaded with ions can be routed to flow path 658 by opening valve 652, or deionized water 202 can be provided from tank 224 by operating a pump 660. From pump 660, the deionized water flows through a check valve 656 to path 658. Cross-flow valves 654a and 654b are opened and closed simultaneously with purge valves 632a and 632b, respectively, to thereby aid in purging the sludge from the chambers.

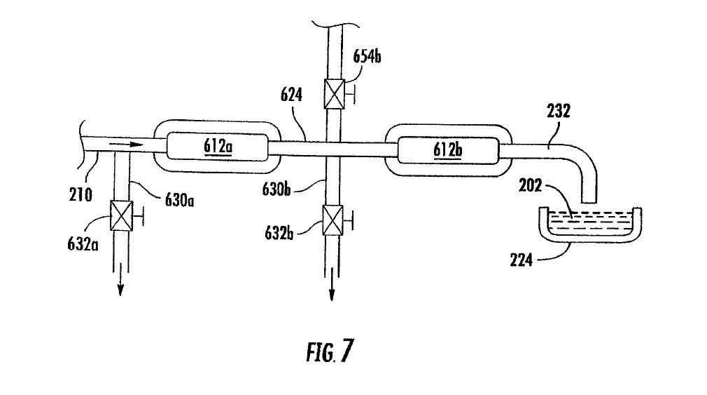

FIG. 7 is a simplified representation of a deionizing or ion separating arrangement according to an aspect of the disclosure. Elements of FIG. 7 corresponding to those of FIG. 6 are designated by like reference alphanumerics. In FIG. 7, the perforated graphene sheets 612a and 612b are rolled or spiral-wound into cylindrical form, and inserted into housings illustrated as 712a and 712b, respectively, as know from the RO membrane arts.

Those skilled in the art will understand that ions other than chlorine and sodium may be removed from water by selectively perforated graphene sheets.

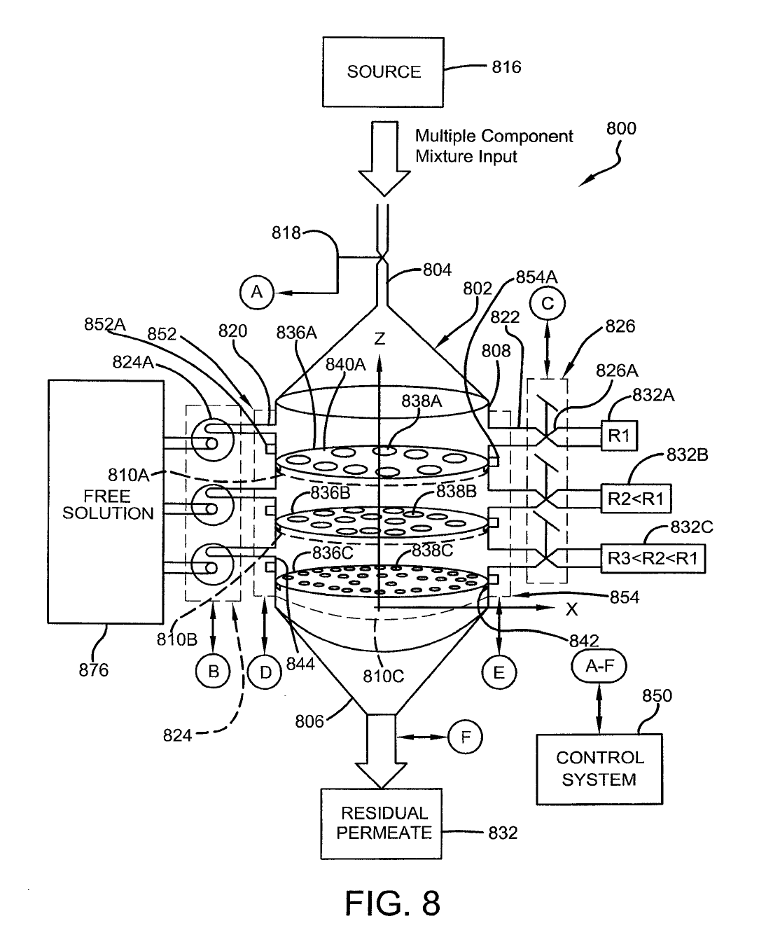

Referring now to FIG. 8, it can be seen that a manifold for harvesting, capturing and retaining compounds is designated generally by the numeral 800. The manifold 800 includes a vessel 802 that receives a fluid, gas or any other multi-component solution or mixture. The vessel includes a primary inlet 804 that is situated at the top of the vessel and a primary outlet 806 at the bottom of the vessel. It will be appreciated that the vessel could be pressurized or not and it may be shaped as shown with a conical top portion and a funnel shaped bottom portion. However, the vessel may be appropriately sized and adapted to any shape as required by the received material and/or the methods of capturing and retaining the desired components from the solution or mixture in a manner to be described.

The vessel 802 receives through the primary inlet 804 a multi-component solution or mixture which contains a plurality of both desired and unwanted components which in some embodiments may be dissolved into solution. Those skilled in the art will appreciate that the solution may be aqueous, or water based, or organic in nature, either of which is sufficient to dissolve the components into solution. The vessel 802 is constructed of a wall 808 which substantially extends from the inlet 804 to the outlet 806. In some embodiments, the wall may be divided into sections 810 which are modularly assembled and separable so as to allow for internal access to the vessel 802. Each section, whether modularly configured or not, is provided with a corresponding alphabetic suffix (A, B, etc), along with each component associated with a particular section. It will further be appreciated that the sections when assembled are secured and sealed to one another so as to prevent contaminating components from entering the vessel and to prevent solution from inadvertently exiting the vessel. The multi-component solution or mixture is directed from a material source 816 wherein the material may be pre-filtered or not.

Each section 810 is provided with a cross-flow entry port 820 and a cross-flow exit port 822. In most embodiments, the ports 820 and 822 will be diametrically opposed to one another; however, it will be appreciated that in other embodiments the ports may be arranged in a manner conducive to harvesting the retained materials from the muti-component solution as will be described. Further associated with each section 810 is a pump 824 associated with a cross-flow entry port 820. Each exit port 822 has associated therewith a valve 826. A collection vessel 832 is associated with each section 810 to receive the desired components in a manner that will be described. Although the vessel 802 is shown as having three sections 810A, 810B and 810C, it will be appreciated that other embodiments may provide for a single wall vessel which may have any number (1, 2, 4 or more) of cross-flow entry ports and cross-flow exit ports as required based upon the molecules and or constituents to be captured from the multi-component solution.

Associated with each section 810, if provided, or associated with corresponding ports 820 and 822 is a perforated graphene membrane 836. Each perforated graphene membrane 836 in the embodiments to be described is configured to provide the attributes and characteristics of the filter membrane 212/graphene sheet 310 described previously. Each graphene membrane 836 is provided with a plurality of holes 838 which are sized to allow passage of certain components while preventing passage of other components. In the embodiment shown it will appreciated that three graphene membranes 836 are provided. The graphene membrane 836 with the largest diameter hole diameter is positioned at the top portion of the vessel 802 or in closest proximity to the inlet valve 818. The membrane 836 is secured, and in some embodiments detachably affixed to suitable support structures maintained within the vessel 802. In particular, a membrane support 842 extends from an internal surface 844 of the wall 808 so as to hold the graphene membrane in place. As previously described, in some embodiments a backing material or a backing sheet, which may be made of polytetrafluoroethane, selectively perforated polycarbonate, or the like, may be used to undergird, support or otherwise facilitate positioning and support each membrane 836 in the vessel 802. As previously mentioned, when more than one graphene membrane 836 is positioned in the vessel 802 then the membrane closest to the inlet valve 818 has the largest diameter hole diameter and is positioned in closest proximity thereto. The graphene layers are then positioned in a vertical sequence in the Z direction of decreasing perforation diameter. In other words, if multiple graphene membrane are provided in the vessel, each graphene membrane positioned underneath another graphene membrane will have smaller diameter holes or apertures than the graphene membrane immediately above. As the solution flows from the inlet valve 818 and through the graphene membranes 836 toward the outlet valve 828, the multi-compartment solution falls past each of the successive graphene membranes that have decreasing hole diameter so that the molecular compounds of successively smaller diameter accumulate on an upper surface 840 of each membrane. In this manner, several molecules or constituents of the multi-component a solution may be harvested and captured.

A control system 850 is connected to the various pumps 824, inlet valves 818, and outlet valves 826 so as to control the flow of solution through the vessel and when appropriate control of cross-flow solutions that are distributed across the graphene membranes so as to collect the accumulated molecules. Skilled artisans will appreciate that the control system 850 provides the necessary hardware and software for receiving information from the various components of the manifold and to control their operation. Each component of the manifold 800 that is connected to, monitored by and controlled by the control system is designated by a capital letter A-F. By way of example, all the pumps 824 are linked with the control system by capital letter B.

Associated with each graphene membrane 836 and the control system 850, and if appropriate, each section 810 of the vessel 802 is a detection device 852. The detection device 852 is associated with each membrane and monitors the accumulation of molecules on the graphene membrane 836 that do not pass through the membrane. The detection device 852 may be an optical device by which a transmission spectrum amplitude is measured and compared to a reference value. This information is provided to the control system 850. Another type of detection device 852 is an electrical device by which either the resistance or impedance of the membrane changes in accordance with an accumulated amount of material. In other words, as a predetermined level of molecules accumulate on the membrane, its resistance value changes accordingly and the control system 850 detects when a predetermined threshold is reached so as to stop the flow of material by closing the inlet valve 818 and allow for the accumulated molecules to be harvested. And still another detection device 852 may comprise a mechanical device by which the natural frequency and damping modes of the graphene membrane change in response to an accumulated amount of matter. Accordingly, once the detection device 852 detects by any of the means described above that a predetermined threshold amount of molecules have accumulated on any one of the graphene membranes or by any combination of the graphene membranes, the control system 850 shuts the inlet valve 818 and allows the remaining molecules to fully settle and accumulate for harvest. At the appropriate time, the control system 850 begins dislodging of the compounds from the surface of the appropriate graphene membrane 836 so that the molecules may be captured and retained as will be discussed.

As shown in FIG. 8, the control system 850 is connected to the detection devices 852 represented by the capital letter D and also to a number of dislodging devices 854 represented by the capital letter E. In other words, any one of the optical devices may be associated with any one of the membranes shown and in a similar manner any one of the dislodging devices 854 to be disclosed, is connected to any one of the membranes 836 shown. It is envisioned that the dislodging apparatuses disclosed herein are maintained within the vessel; however, in other embodiments it is conceivable that the appropriate section 810 could be dismantled whereupon the dislodging apparatus 854 is then associated with the graphene membrane.

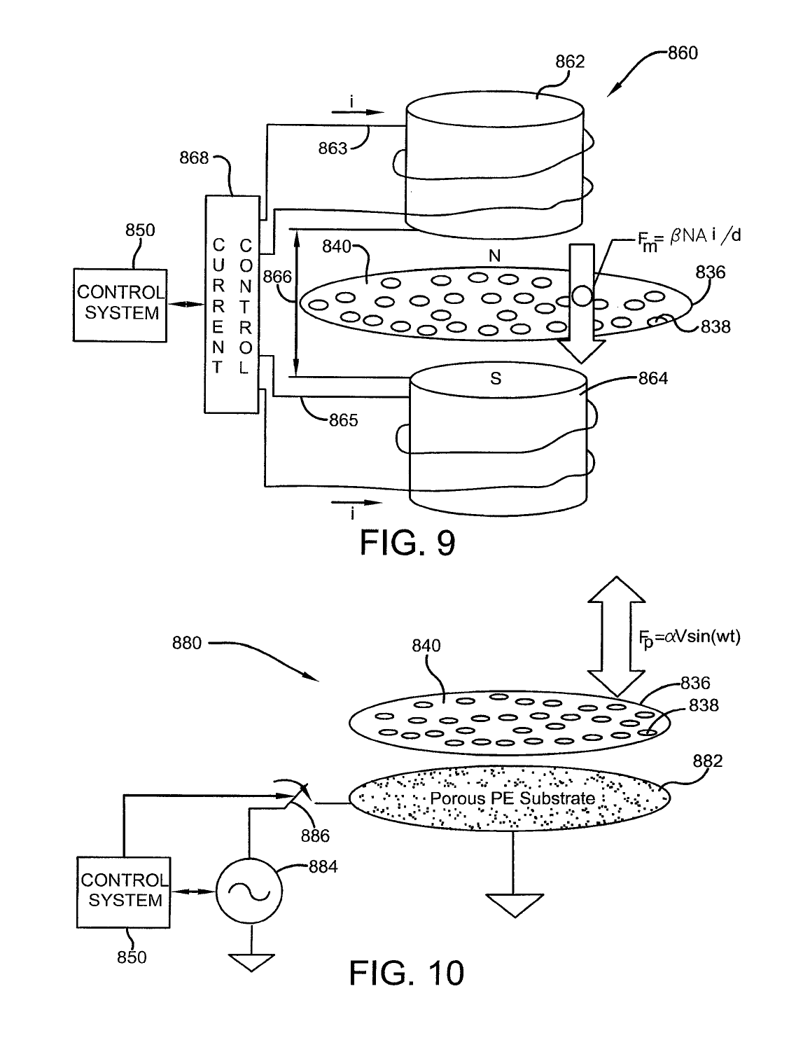

Referring now to FIG. 9, one dislodging apparatus is designated generally by the number 860 and is referred to as an electromagnetic dislodging apparatus. In this embodiment a pair of electromagnetic coils 862, 864 are associated with the graphene layer 836. The graphene membrane 836 is positioned between the electromagnetic coils 862 and 864 which have a gap 866 formed therebetween defined by a distance d. Each electromagnetic coil is associated with a wire 863 and 865 respectively. A current source 868, which is controlled by the control system 850 is utilized to simultaneously, or in a coordinated sequence, send a current along one of the wires to one of the electromagnets so as to generate a magnetic force. In particular, it will be appreciated that generation of the current generates a magnetic dipole moment (Fₘ=βNAi/d) controlled in direct proportion to the current applied to the coil. Accordingly, for all classes and sizes of ferro-magnetic materials or molecules trapped on the membrane upper surface 840, a dislodging Z-direction force is generated and controlled to elevate the material into a free solution 876. The free solution 876, as shown in FIG. 8, is cross-flushed via the pump 824 through the entry port 820 and the section 810 so as to harvest the molecules dislodged from or still accumulated on the surface 840 of the graphene membrane 836. Accordingly, as the free solution 876 flows through the section 810, the dislodged material is absorbed and/or otherwise propelled through the exit port 822 and an open valve 826 and into an appropriate collection vessel 832 for further treatment or refinement. In operation, the dislodging apparatus 860 may be first operated and then after a period of time the appropriate pump 824 associated with the adjacent entry port 820 is operated so as to flow the free solution across the surface of the graphene membrane so as to absorb or carry the dislodged molecules in the free solution and to collect them through the outlet or exit port 822 and to the appropriate vessel 832. The control system 850 provides the appropriate sequence of operational events to capture the harvested molecules.

Referring now to FIG. 10, another dislodging apparatus is designated generally by the number 880. The dislodging apparatus 880 is an electromechanical device wherein a porous piezo-electric substrate 882 is associated with the graphene membrane 836. The porous-piezo-electric substrate 882 is provided with apertures significantly larger than the holes 838 to allow through flow of the unblocked solution. It will be appreciated that the substrate 882 has a ground connection. The substrate 882 is positioned to be adjacent to and in close proximity to or in touching contact with the membrane 836. The substrate 882 is connected to a voltage source 884 which is connected to the control system 850. A switch 886, which is shown in the open position, is also controlled by the control system 850 and is connected between the voltage source 884 and the substrate 882. The control system 850 controls the voltage amplitude and the switch frequency (the rate and timing of when the switch 886 is opened and closed) so as to generate a dislodging force Fₚ=αV sin(wt), such as a vibration, so as to dislodge the accumulated molecules from the graphene membrane and in particular the surface 840 so that it can be absorbed and/or cleared away by a free solution 876 passing over the membrane 836 in a manner substantially the same as in the previous embodiment. In any event, the membrane 882 acts as a support structure to the graphene membrane whose vertical Z-direction deformation versus time can be controlled in direct proportion to the applied voltage through the switch 886. It will be apparent to those skilled in the art that any suitable piezo-electric membrane may be used in this application including polyvinylidene-tri-fluoride or any other flouro-polymer material. For all classes and sizes of molecules captured on the membrane surfaces, a dislodging Z-direction force is generated and controlled to elevate the material into free solution where it may thereafter be cross-flushed and harvested into a collection vessel 832.

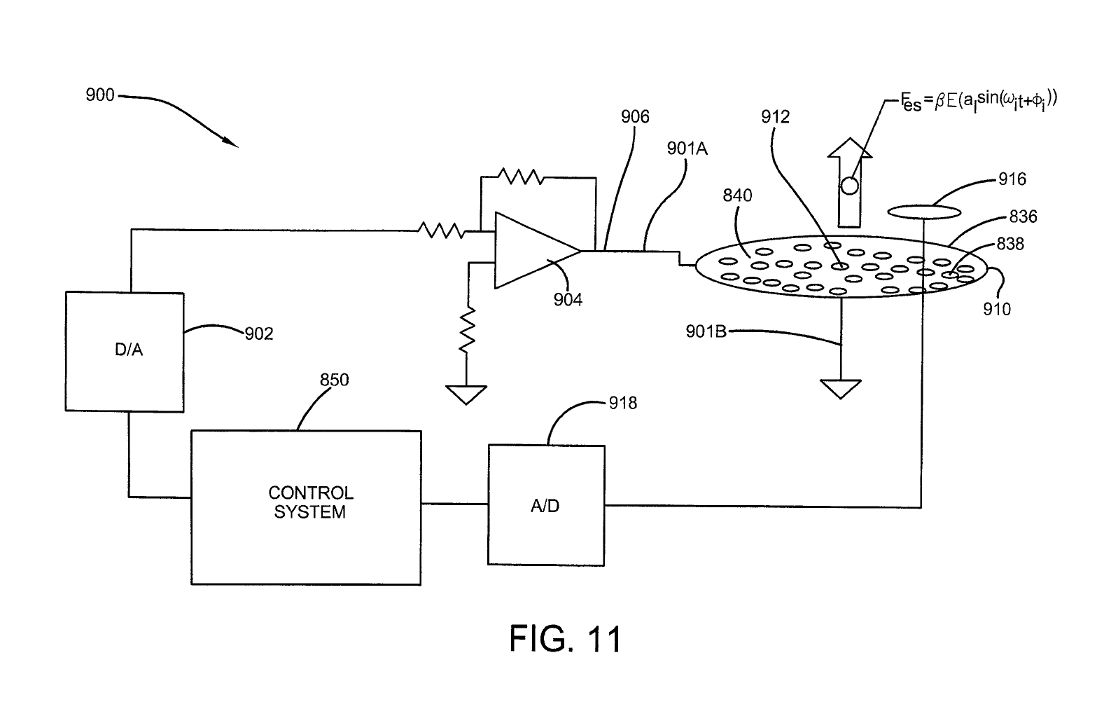

Referring now to FIG. 11, it can be seen that an electrostatic dislodging apparatus is designated generally by the number 900. In this embodiment, the graphene membrane 836 is associated with the control system 850 wherein wires are attached to the membrane 836 with a first wire 901A attached to an outer periphery of the membrane, and a second wire 901B attached between ground and a ground reference near a center or in close proximity to a center of the membrane 836. The dislodging apparatus 900 includes a digital-to-analog converter 902, which is connected to and controlled by the control system 850, that supplies an analog signal to an operational amplifier 904 which generates an electromagnetic wave signal 906. The wave signal 906 is applied to the outer periphery of the graphene membrane 836 via the wire 901A. Because of the unique conductive property of graphene, an electromagnetic wave is generated by application of the wave signal 906 to the outer diameter of the perforated graphene membrane. The wave signal 906 generates a wave force

Fₑₛ=βE(a₁ sin(ωᵢt+φᵢ)). The wave propagates inwardly toward the ground reference in accordance to the relative voltage difference between the ground and outer diameter of the graphene membrane. As the material accumulated on the graphene membrane is electrostatically repelled vertically in response to the electrostatic force, the material's concentration in the free solution is sensed by a conductivity meter 916. The meter 916 is connected to the control system 850 through an analog-to-digital converter 918 to moderate the applied wave time series to maximize material dislodgement. Once a predetermined threshold value of conductivity is detected by the meter 916, the control system 850 continues with the cross-flow flushing of the free solution and associated material as described in the previous embodiments.

As discussed above, when multiple graphene membranes are utilized, the aperture size for each membrane goes from a larger to a smaller diameter. For example, molecules that are blocked by the first graphene membrane and designated as R1, while slightly smaller molecules are blocked by graphene membrane 836B and are identified as R2. Finally, molecules that are even smaller are identified as R3 and are blocked by graphene membrane 836C. Molecules that are not blocked by any of the membranes pass through, and are identified as the permeate collected in collection vessel 832.

The control system 850 coordinates operation of the valves 818 and 826, the pumps 824, and the dislodging mechanisms 854 in an efficient manner so as to minimize power applied and to collect the desired molecules. It will further be appreciated that the control system 850 and the associated dislodging mechanisms may be configured to drive the accumulated material on the surface 840 across the membrane 836 to the outer circumference of the membrane and the housing 820 to facilitate capture thereof.

The advantages of the present invention are readily apparent. In particular, the apparatus 800 can effectively harvest specifically sized molecules and effectively remove them from a surface of a graphene membrane. This is useful where molecules cake and otherwise accumulate in a manner where they cannot be easily dislodged by a simple cross-flow of solution. The vessel and related methodology permits removal of the molecules without having to remove the membranes from the vessel. The unique conductive property of graphene allows application of the aforementioned electrical dislodging and harvesting means, in a manner not afforded to existing polymer, and hence insulating, membranes in current practice.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A method for collecting molecules from solution comprising:
providing at least one graphene membrane perforated with a plurality of apertures selected to allow passage of the solutions' solvent while simultaneously arresting desired molecules upon a surface of said at least one graphene membrane; and
dislodging the accumulated desired molecules from said surface for capture and retention.

2. The method according to claim 1 further comprising:
halting flow of said solution when accumulation of said desired molecules reaches a predetermined amount.

3. The method according to claim 2, wherein dislodging comprises:
locating two electromagnet coils spaced above and below said at least one graphene membrane; and
applying controlled current to said electromagnetic coils to generate an electromagnetic attraction force on any one of said molecule constituents responsive to Ferromagnetic attraction so as to dislodge said molecules from said surface.

4. The method according to claim 3, further comprising:
flowing a free solution across said surface to harvest the desired dislodged molecules.

5. The method according to claim 2, wherein dislodging comprises:
associating said at least one graphene membrane with at least one porous piezo-electric substrate; and
applying a voltage to said at least one porous piezo-electric substrate to produce mechanical deflection causing vertical dislodging of one of said molecule constituents so as to dislodge said molecules from said surface.

6. The method according to claim 5 further comprising:
flowing a free solution across said surface to harvest the desired dislodged molecules.

7. The method according to claim 2, wherein said dislodging method comprises:
connecting an electromagnetic wave generating circuit between an outer diameter and a proximal center reference of said at least one graphene membrane; and
applying an electromagnetic wave to at least one graphene membrane to produce a combined lateral charge and vertical mechanical deflection causing vertical dislodging of one of said desired molecule constituents so as to dislodge said molecules from said surface.

8. The method according to claim 7, further comprising:
flowing a free solution across said surface to harvest the desired dislodged molecules.

9. An apparatus for selectively harvesting molecules, comprising:
a vessel having an inlet and an outlet, said inlet receiving a solution and said outlet collecting said solution's solvent;
at least one graphene membrane perforated with a plurality of apertures selected to allow passage of said solution's solvent while simultaneously arresting desired molecules upon a surface of said at least one graphene membrane; and
a dislodging device associated with said at least one graphene membrane to dislodge said desired molecules from said surface.

10. The apparatus according to claim 9, further comprising:
a detection device associated with said at least one graphene membrane to monitor accumulation of said desired molecules upon said surface.

11. The apparatus according to claim 9, further comprising:
a cross-flow inlet and a cross-flow outlet associated with said vessel, said cross-flow inlet positioned to distribute a free solution over said at least one graphene membrane to harvest the desired dislodged molecules and wherein said cross-flow outlet accumulates said free solution and desired dislodged molecules.

12. The apparatus according to claim 11, wherein said dislodging device comprises:
a pair of electromagnetic coils having a gap therebetween, wherein said at least one graphene membrane is received in said gap; and
a current source applying current to at least one of said electromagnetic coils to generate an electromagnetic attraction force to dislodge said desired molecules from said surface.

13. The apparatus according to claim 11, wherein said dislodging device comprises:
at least one porous piezo-electric substrate associated with said at least one graphene membrane; and
a voltage source connected to said at least one porous piezo-electric substrate to generate a mechanical deflection and dislodge said desired molecules from said surface.

14. The apparatus according to claim 11, wherein said dislodging device comprises:
an electromagnetic wave generating circuit connected between an outer edge of said at least one graphene membrane and a proximal center reference of said at least one graphene membrane, wherein generation of said electromagnetic wave generates a combined lateral charge and vertical mechanical deflection causing dislodging of said desired molecules from said surface.
